(19) United States
(12) Patent Application Publication
(10) Pub. No.: US 2008/0141857 A1
(43) Pub. Date: Jun. 19, 2008

(54) Air conditioner compressor having friction member in cylinder

(75) Inventor: Yu Jin Bae, Gyeonggi-do (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/818,714

(22) Filed: Jun. 14, 2007

(30) Foreign Application Priority Data
Dec. 15, 2006 (KR) 10-2006-0128887

(51) Int. Cl. F16J 10/04

(52) U.S. Cl. 92/169.2

(57) ABSTRACT

Disclosed herein is an air conditioner compressor for a vehicle, which comprises a friction member mounted replaceably on the inner wall of the cylinder bore in which the piston reciprocates so as to come in contact with the friction member. The present air conditioner compressor may further comprise a spring member disposed between the outer circumferential surface of the friction member and the inner wall of the cylinder bore. The present invention provides an advantage that it is possible to remanufacture worn cylinders simply by replacing friction members.

### CROSS-REFERENCE TO RELATED APPLICATION

This application claims the benefit under 35 U.S.C. §119(a) on Korean Patent Application No. 10-2006-0128887 filed on Dec. 15, 2006, entire contents of which are incorporated herein by reference.

### BACKGROUND OF THE INVENTION

1. Field of the Invention

The present invention relates to an air conditioner compressor having a friction member embedded in a cylinder and, more particularly, to an air conditioner compressor equipped with a friction member that is replaceably mounted on the inner wall of a cylinder bore, wherein the inner wall of the friction member is configured to contact a piston reciprocating in the cylinder bore.

2. Background Art

A compressor is a main part of an air conditioning system. The compressor is adapted for compressing a refrigerant gas at a low temperature and pressure into a gas at a high temperature and pressure, and supplying the compressed gas to a condenser.

FIG. 1 is a sectional view depicting an internal structure of an air conditioner compressor.

As depicted in the figure, the air conditioner compressor 100 comprises a cylinder unit and a clutch unit. The cylinder unit includes cylinder 110, a swash plate 121, a shoe 122, a piston 123, etc. The clutch unit includes a pulley 131, a disc 132, a coil 133, etc. Normally, the air conditioner compressor 100 does not operate when the pulley 131 and the disc 132 are separated from each other. If the air conditioner is turned on, the pulley 131 and the disc 132 come in contact with each other by an electro-magnetic force generated from the coil 133, which makes the air conditioner compressor operate.

As a rotational force of an engine is transmitted in the sequential order of the disc 132, the shaft 134, the swash plate 121 and the piston 123, the piston 123 reciprocates back and forth inside a cylinder bore 121a and thereby a refrigerant in the cylinder is compressed and supplied to the condenser.

Meanwhile, a primary cause that gets air conditioners out of order is internal wear or damage of the air conditioner compressors. Compressors are expensive. For this reason, recycled compressors are demanded than newly manufactured compressors.

However, most of recycled compressor manufacturers are small-sized companies and they do not have techniques or equipments that can precisely repair or recycle compressors having a relatively complicated structure.

In most cases, compressors can be remanufactured by replacing simple parts such as an oil seal and washing the resulting compressors. The recycled compressors thus manufactured have been sold at low prices in market. Sometimes, however, internal parts such as a cylinder having a complicated structure, a shaft, a swash plate and the like are worn or damaged. In this case, compressors are hard to be repaired; they are dumped or sold for junk, instead.

In other words, only simples parts such as a oil seal and the like that are visually perceived can be replaced and washed to recycle the disabled compressors. By contrast, if the main parts such as a cylinder are worn (e.g., if the inner wall of the cylinder bore within which the piston comes in contact is worn), they cannot be repaired, thereby causing a great deal of loss in terms of resource circulation.

Moreover, if an air conditioner compressor is used for a long period of time, the inner wall of the cylinder bore with which the piston comes into contact while reciprocating tends to get worn. If the inner wall of the cylinder bore is worn out, the compression efficiency decreases, thereby deteriorating the cooling efficiency of the air conditioner, causing the leakage of a refrigerant and an oil, and generating a noise.

Since a mechanical wear as well as a change in a metal structure are generated by friction heat in the worn portion in the cylinder, the strength and performance of the cylinder are hard to be maintained.

For this reason, the entire compressor should be replaced even if the cylinder is simply worn, which increases vehicle maintenance expenses.

It costs, however, a lot to melt and remanufacture the worn cylinders. Further, the concentration of impurities and pores can be increased in the melting and remanufacturing processes, thus deteriorating the purity and quality of the remanufactured cylinders considerably.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to provide an air conditioner compressor that can be easily remanufactured so as to save energy and reduce vehicle maintenance expenses.

In one aspect, the present invention provides an air conditioner compressor adapted for compressing and supplying a refrigerant by reciprocating a piston in a cylinder bore, the air conditioner compressor comprising a friction member mounted replaceably on the inner wall of the cylinder bore in which the piston reciprocates so as to come in contact with the friction member.

In a preferred embodiment, the air conditioner compressor further comprises a spring member disposed between the outer circumferential surface of the friction member and the inner wall of the cylinder bore, wherein the outer circumferential surface of the spring member is closely fixed to the inner wall of the cylinder bore by an elastic restoring force thereof and the inner circumferential surface of the spring member is adhered and fixed to the outer circumferential surface of the friction member.

Preferably, the spring member is formed in a cylindrical shape with one side thereof open in a longitudinal direction and the spring member is closely fixed to the inner wall of the cylinder bore by the elastic restoring force widening toward the outside.

Suitably, the elastic restoration force of the spring member is greater than the force exerted by the piston on the spring member in the moving direction of the piston on the inner wall of the cylinder bore.

Also suitably, the spring member may be made of a material that does not damage the inner wall of the cylinder bore.

The friction member and the cylinder may be made of the same material. The friction member and the cylinder may be made of different materials. Preferably, the friction member is made of a material having a wear resistance higher than that of the cylinder.

In another aspect, motor vehicles are provided that comprise a described air conditioner compressor.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present air conditioner compressors will be particularly useful with a wide variety of motor vehicles.

Other aspects of the invention are discussed infra.

### BRIEF DESCRIPTION OF THE DRAWINGS

The above and other features of the present invention will be described with reference to certain exemplary embodiments thereof illustrated the attached drawings in which:

FIG. 1 is a sectional view depicting the internal structure of an air conditioner compressor;

FIG. 2 is a sectional perspective view depicting a state in which a friction member is mounted on a cylinder of an air conditioner compressor in accordance with the present invention;

FIG. 3 is a perspective view depicting a state in which a friction member and a spring member are assembled in an air conditioner compressor in accordance with the present invention; and

FIG. 4 is a cross-sectional view depicting a state in which a spring member is fixed to a cylinder of an air conditioner compressor in accordance with the present invention.

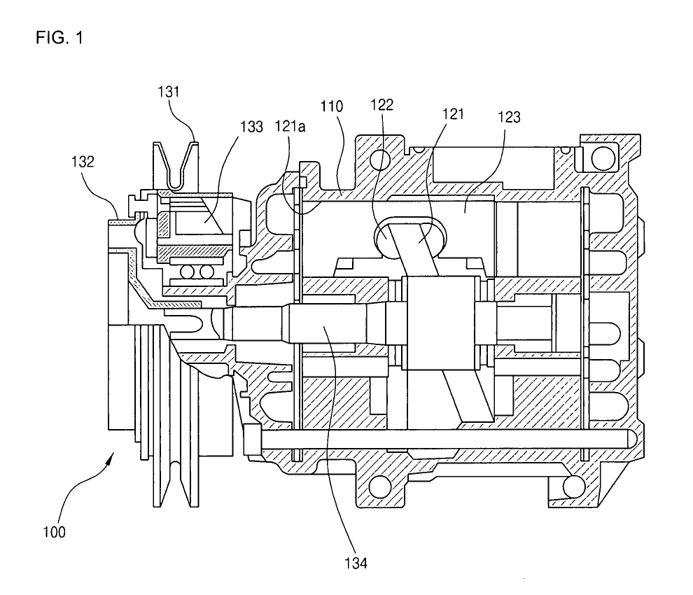

### DETAILED DESCRIPTION

Hereinafter, preferred embodiments in accordance with the present invention will be described with reference to the accompanying drawings. The preferred embodiments are provided so that those skilled in the art can sufficiently understand the present invention, but can be modified in various forms and the scope of the present invention is not limited to the preferred embodiments.

The present invention relates to an air conditioner compressor having a friction member inserted into a cylinder. In order to solve the problems of the conventional art in which it is impossible to remanufacture a worn cylinder in which the inner wall of a cylinder bore is worn by a reciprocating piston, the present invention provides a friction member mounted replaceably on the inner wall of the cylinder bore. By this arrangement, it is possible to readily replace the friction member after a long period of use to remanufacture the worn cylinder.

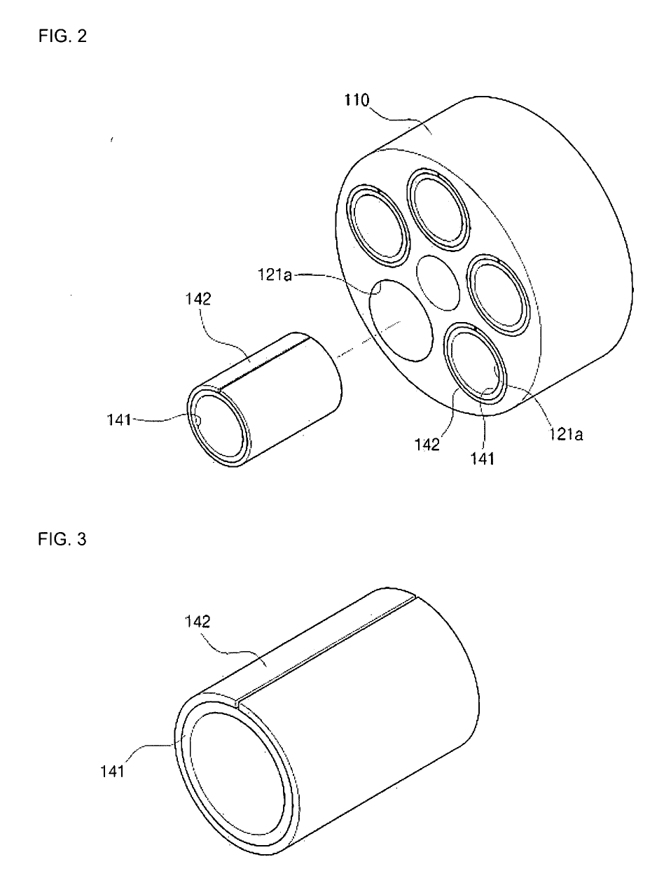

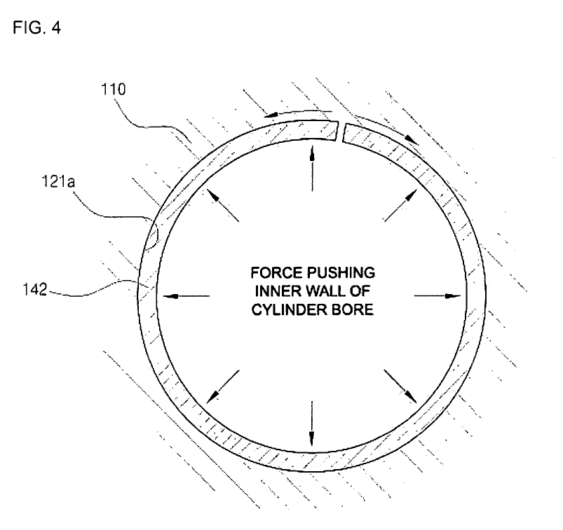

FIG. 2 is a sectional perspective view depicting a state in which a friction member is mounted in a cylinder of an air conditioner compressor in accordance with the present invention, FIG. 3 is a perspective view depicting a state in which a friction member and a spring member are assembled in an air conditioner compressor in accordance with the present invention, and FIG. 4 is a cross-sectional view depicting a state in which a friction member is fixed to a cylinder of an air conditioner compressor in accordance with the present invention.

As depicted in the figures, a friction member 141 is mounted replaceably on the inner wall of a cylinder bore 121a in which a piston reciprocates in the air conditioner compressor in accordance with the present invention so that the reciprocating piston comes in contact with the inner wall of the friction member 141.

Here, the friction member 141 is formed in a cylindrical shape having an outer diameter capable of being inserted and mounted into the inside of the inner wall of the cylinder bore 121a. The inner diameter of the friction member 141 is the same as that of the conventional cylinder bore.

In other words, if a piston having the same diameter as the conventional one is used, the inner diameter of the friction member 141 that is added in accordance with the present invention should be the same as that of the conventional cylinder bore (the diameter that the piston can compress refrigerant while reciprocating inside the cylinder bore).

In the conventional compressors, a piston reciprocates while coming in contact with the inner wall of the cylinder bore. In the present invention, by contrast, the friction member 141 in the cylindrical shape is added to the inside of the cylinder bore 121a and the piston reciprocates while coming in contact with the inner wall of the friction member 141. Accordingly, it is natural that the inner diameter of the friction member should be the same as that of the conventional cylinder bore.

Moreover, as the surface of the piston is coated with several materials such as silicon and the like, the friction member 141 may be made of an aluminum alloy that is the same material as the existing cylinder (the inner wall of the cylinder bore) or made of any material having excellent wear resistance more than the existing cylinder (the inner wall of the cylinder bore).

Meanwhile, in mounting the friction member on the inner wall of the cylinder bore in accordance with the present invention, a spring member 142 is used to prevent the friction member 141 from being pushed out while the piston reciprocates.

That is, the spring member 142 is disposed between the inner wall (the inner circumferential surface) of the cylinder bore 121a and the outer circumferential surface of the friction member 141. The spring member 142 is formed in a cylindrical shape rolled round and one side thereof is open in the longitudinal direction.

Elastic restoring force of the spring member 142 in such a cylindrical structure rolled round acts in the radial direction toward the outside. Since the spring member 142 has a force pushing outwardly, the spring member 142 to which the friction member 141 is attached is fixed (pressurized and, at the same time, adhered closely) to the inner wall of the cylinder bore 121a, not slid.

Here, it is preferable that the spring member 142 be manufactured by considering the spring rigidity so that the force pushing outward by the elastic restoring force of the spring member (adhering force pushing the inner wall of the cylinder bore) is greater than the force exerted by the piston on the spring member that tends to move in the moving direction of the piston on the inner wall of the cylinder bore (pushing force of the spring by the spring rigidity>moving force in the moving direction of the piston. Moreover, it is also preferable that the spring member 142 be manufactured so that the strength of the spring member material should not damage the inner wall of the cylinder bore. As described above, the friction member is readily fixed to the spring member more than directly to the inner wall of the cylinder bore. Especially, since the friction member is mounted on the inner wall of the cylinder bore via the spring member, it is possible to readily replace the friction member by taking the spring member out of the cylinder.

The spring member and the friction member can be adhered to each other using a various kinds of methods including metal bonding adhesive or a brazing welding process. Of course, the other suitable bonding processes may be used considering the material of the spring member, bonding ability and costs.

As described above, the air conditioner compressor in accordance with the present invention has an advantage in that it is possible to remanufacture the worn cylinders by readily replacing the friction member mounted on the inner wall of the cylinder bore, with which the piston comes in contact while reciprocating in the conventional art, after a long period of use.

A new cylinder for an air conditioner compressor may be manufactured by inserting a friction member into the cylinder. In this case, the friction member may be replaced, if necessary.

In case of a (worn) cylinder which does not have a friction member inserted therein, it is possible to remanufacture the cylinder by inserting a new friction member, without having to cutting or melting the cylinder. A new friction member with an appropriate size can be inserted. Before the insertion, the wear degree of the friction member should be measured.

In other words, worn cylinders can be recycled simply by inserting a new friction member in the cylindrical shape, thus maintaining the inner diameter of the cylinder the same as the new compressor.

The compressors are not so different in their structures according to the vehicle types but classified into several types mainly by their capacities.

Accordingly, a cylindrical sample having an outer diameter the same as that of a new cylinder bore designed by the capacity types is inserted into a worn cylinder bore to measure the difference in their radiuses, thus measuring the wear degree of the inner wall of the cylinder bore.

Here, the cylindrical sample is a cylindrical member for measuring the wear degree of the inner wall of the cylinder bore, and the radius (outer diameter) of the cylindrical sample is manufactured to have the same size as the inner diameter of the new cylinder bore.

If the inner diameter of the worn cylinder bore is referred to as ‘a’ and the inner diameter of the new cylinder bore (the outer diameter of the cylindrical sample) is referred to as ‘b’, the wear degree ‘c’ of the cylinder to be measured can be defined as ‘c=a−b’.

However, only the stress by the reciprocating movement of the piston should be considered on the assumption that the stress that the inner wall of the cylinder bore receives is not different depending on the location.

Moreover, it is possible to measure accurate wear degree only if the cylindrical sample and the cylinder bore are placed on a concentric circle. Since the cylindrical sample is used to measure the wear degree, the cylindrical sample should be made of a material that does not damage to the inner wall.

The friction members (the inner diameter thereof is the same as that of the new cylinder bore) to be inserted into the inside of the cylinder bore can be prepared to have various thicknesses. An appropriate friction member thus can be instantly inserted after the measurement of the wear degree as described above in remanufacturing process, thus improving the process efficiency.

When the remanufacturing process is performed in large quantities, it is desirable to use a machine that can measure the wear degree of the cylinder more rapidly and accurately although it is expensive.

If the distance between the circular center of the cylinder bore and the inner wall of the cylinder bore is measured using ultrasound (the wear degree can be measured three dimensionally) and, thereafter, if the difference value between the measured distance and the inner diameter of the new product is measured, it is possible to readily calculate the thickness of the necessary friction member.

As described in detail above, the air conditioner compressor in accordance with the present invention has the following advantages. The worn cylinder can be remanufactured by replacing the friction member replaceably mounted on the inner wall of the cylinder bore with which the piston comes in contact while reciprocating in the conventional art after a long period of use.

As such, if the inner wall of the friction member is worn in a certain period time, the friction member can be simply replaced, thus remanufacturing the worn cylinder repeatedly in a convenient and simple manner, without having to separately process or dump the worn cylinder.

Moreover, the air conditioner compressor in accordance with the present invention has other advantages in that it can be readily remanufactured, without wasting the existing resources, thus saving energy and reducing vehicle maintenance expenses compared with the conventional art in which the worn cylinders are melted to be recycled. Furthermore, the present invention can provide an air conditioner compressor with low price and high quality.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An air conditioner compressor adapted for compressing and supplying a refrigerant by reciprocating a piston in a cylinder bore, the air conditioner compressor comprising a friction member mounted replaceably on the inner wall of the cylinder bore in which the piston reciprocates so as to come in contact with the friction member.

2. The air conditioner compressor as recited in claim 1, further comprising a spring member disposed between the outer circumferential surface of the friction member and the inner wall of the cylinder bore, wherein the outer circumferential surface of the spring member is closely fixed to the inner wall of the cylinder bore by an elastic restoring force thereof and the inner circumferential surface of the spring member is adhered and fixed to the outer circumferential surface of the friction member.

3. The air conditioner compressor as recited in claim 2, wherein the spring member is formed in a cylindrical shape with one side thereof open in a longitudinal direction and the spring member is closely fixed to the inner wall of the cylinder bore by the elastic restoring force widening toward the outside.

4. The air conditioner compressor as recited in claim 3, wherein the elastic restoration force of the spring member is greater than the force exerted by the piston on the spring member in the moving direction of the piston on the inner wall of the cylinder bore.
